(19) United States
(12) Patent Application Publication
(10) Pub. No.: US 2023/0157478 A1
(43) Pub. Date: May 25, 2023

(54) REMOVABLE VORTEX APPARATUS

(71) Applicants: John R. Blichmann, Lafayette, IN (US); Steve Trott, Brook, IN (US)

(72) Inventors: John R. Blichmann, Lafayette, IN (US); Steve Trott, Brook, IN (US)

(21) Appl. No.: 17/994,263

(22) Filed: Nov. 25, 2022

Related U.S. Application Data
(60) Provisional application No. 63/282,828, filed on Nov. 24, 2021.

(51) Int. Cl. A47J 31/20

(52) U.S. Cl. CPC A47J 31/20

(57) ABSTRACT

A removably couplable vortex apparatus for a brewing vessel comprising a first arm portion having a first end and a second end, wherein the second end includes an outlet, wherein the first arm portion is positioned within an interior of the vessel and a second arm portion having a first end and a second end, wherein the second end of the second arm portion includes an inlet, wherein the second arm portion is positioned on an exterior of the vessel. The apparatus can further include a curved portion, having a first end and a second end, wherein the first arm portion extends a first predetermined distance from the first end of the curved portion and the second arm portion extends a second predetermined distance from the second end of the curved portion.

### CROSS-REFERENCE TO RELATED APPLICATION

This U.S. Patent Application claims priority to U.S. Provisional Application: 63/282,828 filed Nov. 24, 2021, to the above-named inventors, the disclosure of which is considered part of the disclosure of this application and is hereby incorporated by reference in its entirety.

### FIELD OF THE INVENTION

This invention relates generally to brewing equipment, namely vessel, components, and method for improving sediment settling and efficiency of immersion chillers and HERMS coils.

### BACKGROUND

As generally known, during the brewing process hops, trub, and other sediment can gather at the bottom of a brewing vessel. During the brewing process it is beneficial to create a whirlpool or other vortex for settling hops and trub to the center bottom of the brewing vessel. Currently a user may manually create a whirlpool or vortex by stirring the liquid in the vessel during the brewing process. Alternatively, other apparatuses currently require a user to hold an apparatus during the process to create a whirlpool during the brewing process. There exists a need for an easily removable couplable apparatus to allow users to easily create a vortex during the brewing process that can be adapted to various brewing apparatuses and maintained in position without external support from a user.

### BRIEF SUMMARY OF THE INVENTION

In one aspect, this disclosure is related to an apparatus to be removably couplable with a brewing vessel, wherein the apparatus is configured to generate a vortex/whirlpool of a liquid within the brewing vessel and any sediment, trub, or hops are moved to the center of an area at the bottom of the vessel. The removably couplable vortex apparatus for a brewing vessel can include a first arm portion, a second arm portion, and a curved portion. The first arm portion can have a first end and a second end, wherein the second end includes an outlet portion and can be positioned within an interior of the vessel. The second arm portion having a first end and a second end, wherein the second end can include an inlet portion and can be positioned on an exterior of the vessel. A curved portion, having a first end and a second end, wherein the first arm portion can extend a first predetermined distance from the first end of the curved portion and the second arm portion extends a second predetermined distance from the second end of the curved portion. The first arm can extend downward from the curved portion at a first angle and the second arm portion can extend down from the curved portion at a second angle. The apparatus can further include a cam member having an aperture that approximates the diameter of the arms of the vortex apparatus and can be removably couplable to the vortex apparatus by sliding the arm of the vortex apparatus through the aperture until in the desired position. The aperture can be formed off center to allow for a user to rotate the cam around the vortex apparatus to change the distance between the second arm portion and the sidewall of the vessel and applying a greater pressure or compressive force against the vessel sidewall to secure the vortex apparatus to the vessel.

In another aspect, this disclosure is related to a method for creating a vortex within a vessel utilizing a removable apparatus. The vortex generated by the apparatus is sufficient to settle hops and trub in the center of a brewing vessel. The method for creating a vortex sufficient to settle hops and trub in the center of a brewing vessel can include first coupling the vortex apparatus of the present disclosure to a vessel by positioning a vessel wall in between the first arm portion and second arm portion. The vortex apparatus can include a first arm portion, a second arm portion, and a curved portion. The first arm portion can have a first end and a second end, wherein the second end include an outlet portion and can be positioned within an interior of the vessel. The second arm portion having a first end and a second end, wherein the second end includes an inlet portion and can be positioned on an exterior of the vessel. A curved portion, having a first end and a second end, wherein the first arm portion can extend a first predetermined distance from the first end of the curved portion and the second arm portion extends a second predetermined distance from the second end of the curved portion. The first arm can extend downward from the curved portion at a first angle and the second arm portion can extend down from the curved portion at a second angle. A liquid can then be pumped from withing the vessel from a vessel outlet to the inlet portion to redirect the liquid through the vortex apparatus and through the outlet back into the vessel, wherein the apparatus directs the liquid along the vessel wall to create a whirlpool/vortex within the vessel.

In yet another aspect, this disclosure is related to a removable cam for adjusting the pressure applied to a vessel by a removably couplable apparatus to a vessel.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of an exemplary embodiment of a whirlpool apparatus of the present disclosure.

FIG. 2 is a perspective view of an exemplary embodiment of a whirlpool apparatus of the present disclosure coupled to a vessel.

FIG. 3A is a first cross-section (A) view of FIG. 2 of the interior wall of the vessel having an exemplary embodiment of a whirlpool apparatus of the present disclosure coupled to the vessel.

FIG. 3B is a second cross-section (B) view of FIG. 2 of the interior wall of the vessel having an exemplary embodiment of a whirlpool apparatus of the present disclosure coupled to the vessel.

FIG. 4 is a top view of an exemplary embodiment of a whirlpool apparatus of the present disclosure coupled to a vessel.

FIG. 5A is a perspective view of an exemplary embodiment of a whirlpool apparatus of the present disclosure.

FIG. 5B is a side view of an exemplary embodiment of a whirlpool apparatus of the present disclosure.

FIG. 5C is another side view of an exemplary embodiment of a whirlpool apparatus of the present disclosure.

FIG. 5D is a top view of an exemplary embodiment of a whirlpool apparatus of the present disclosure.

FIG. 6A is a perspective view of an exemplary embodiment of a cam of the present disclosure.

FIG. 6B is a perspective view of another exemplary embodiment of a cam of the present disclosure.

FIG. 7A is a close-up view of a vessel sidewall with an exemplary embodiment of a vortex apparatus of the present disclosure having a cam positioned in a first position.

FIG. 7B is a close-up view of a vessel sidewall with an exemplary embodiment of a vortex apparatus of the present disclosure having a cam positioned in a second position.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

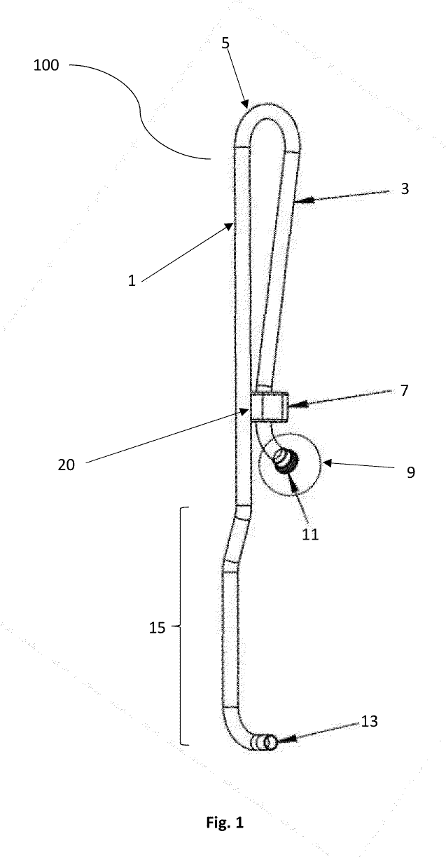

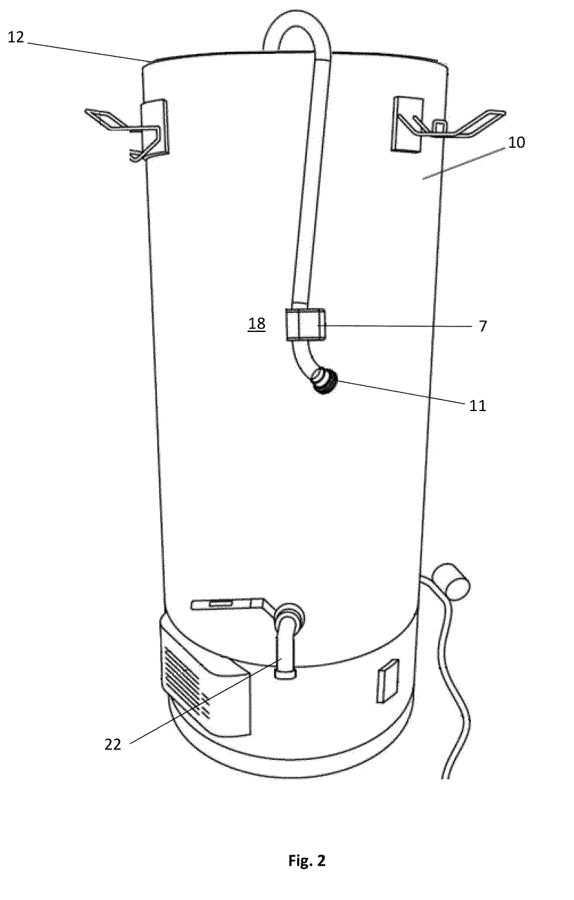

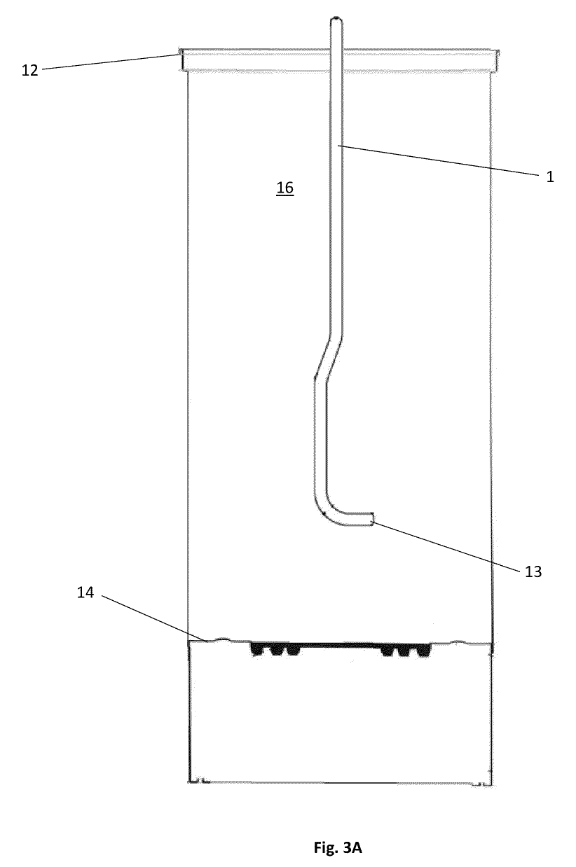

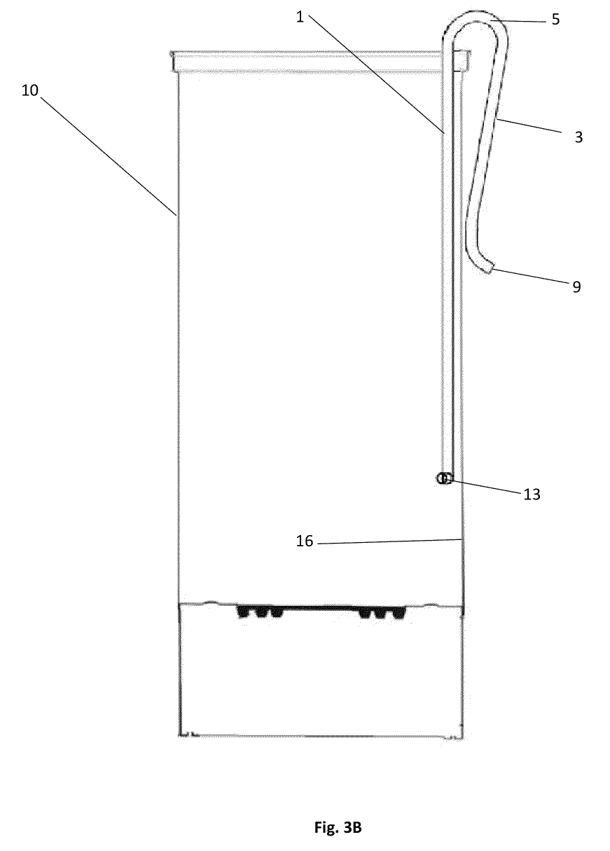

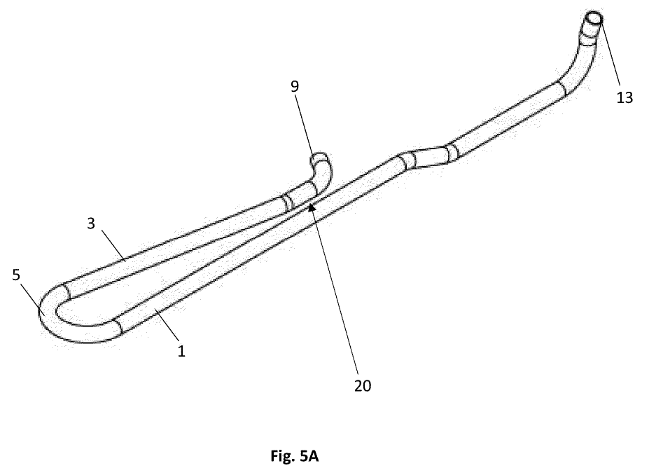

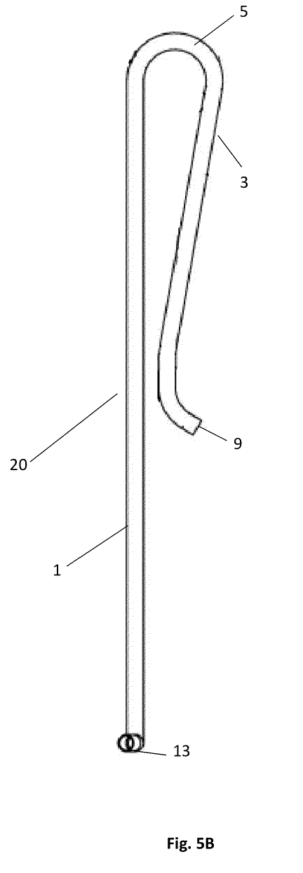

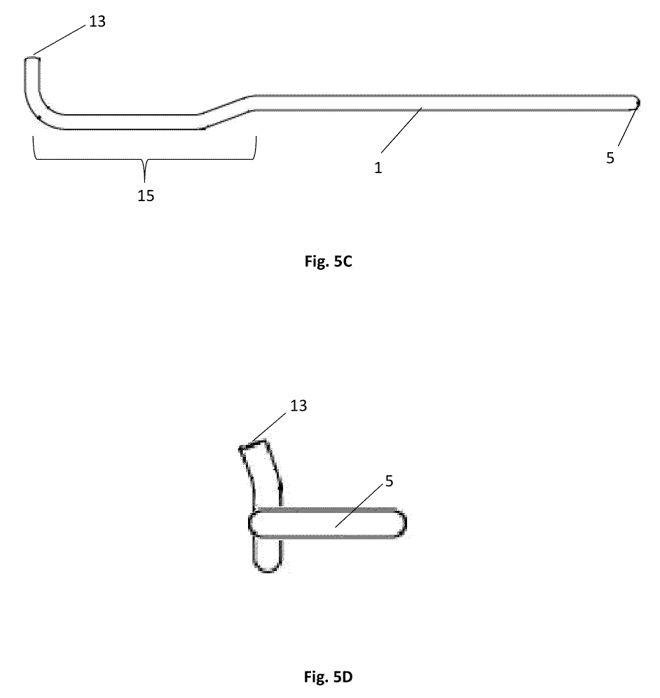

As shown in FIGS. 1-4, an exemplary embodiment of the vortex apparatus 100 of the present disclosure can have a first portion 1 having a predetermined length that can extend within the interior cavity of a vessel 10 and a second portion 3 having a predetermined length that can extend outside on the exterior side/surface of the vessel 10. As shown in FIG. 3, the first portion 1 can extend down the interior wall 16 of the vessel 10. The first portion 1 and second portion 3 can be coupled or formed together and meet at a curvature junction 5 having a radius located between the first portion 1 and second portion 3 of the apparatus 100. An exemplary embodiment of the vortex apparatus 100 can be formed using one or more tubular pieces. In one exemplary embodiment, the vortex apparatus 100 can be formed from a single tubular piece and bend and radiused according. Alternatively, the apparatus can be comprised of one or more tube components to form an exemplary embodiment of the present disclosure. The tube can be constructed from any suitable material, including but not limited to metal, metal alloys, plastic, or polymers. As shown in the FIG. 1, the first and second arm portions 1, 3 can extend down from the curved portion at an angle of attack wherein the first portion and second portion approach each other towards a gap 20. In some exemplary embodiments, the first portion can be generally parallel to the vessel wall 16 and the second portion 3 can follow an angle towards the first arm 1. In some exemplary embodiments, the first arm portion 1 can extend downward from the curved portion at a first angle and the second arm portion can extend down from the curved portion at a second angle. As shown in FIG. 3B, the first angle can be generally parallel to the vessel wall and the second angle can be towards the vessel wall. In some embodiments, both the first angle and second angle can be towards the vessel wall. When the apparatus is applied to a vessel, the gap 20 between the two portions 1, 3 can be minimal as shown in FIG. 5A or the ends of portions 1, 3 may contact each other. A cam 7 can further provide a friction means to allow the apparatus 100 to remain in position when in operation and pressure from the inlet 9 and outlet 13 are induced. As shown in FIG. 1, the cam 7 can additionally fill in the gap 20 between the first arm 1 and second arm 3.

Additionally, the second end/inlet 9 of the second portion 3 can include various coupling means 11 to allow the vortex apparatus 100 to be coupled to a secondary fitting or tube. In some exemplary embodiments, the coupling means 11 can include, but is not limited to, threading, NPT, plain, barb, cam-lock tri-clamp, or any other suitable coupling means. Similarly, the first arm portion can have a first end and a second end. In some exemplary embodiments, the second end can include an outlet portion 13. An aperture at the end of the outlet portion 13 can be located proximate to the gap 20 between the first portion 1 and the second portion 3 of the vortex apparatus 100. In some exemplary embodiments, the first portion 1 can extend downward from the curvature junction 5 along an axis for a predetermined distance. The first portion 1 and second portion 2 can run generally parallel to the axis of the vessel wall. In some exemplary embodiments, the length of the first portion 1 can be more than the length of the second portion 3.

In some exemplary embodiments, the first arm portion 1 can have a section 15 including one or more bends, wherein the direction of the outlet can be bent to a direction that is perpendicular to the axis of the first arm portion 1 and/or generally parallel to the bottom surface 14 of the vessel 10. The bend portion 15 can allow for the liquid passing through the apparatus to direct the liquid around the interior wall 16 of the vessel 10 through the outlet 13 of the bend portion 15. Additionally, one or more additional bends can be added to the first arm portion 1 to add rigidity and limit the twisting of the apparatus 100 during operation. The outlet portion 13 can be positioned to direct the flow of liquid through the apparatus tangentially on the inside wall 16 of the vessel 10 to create a vortex/whirlpool within the vessel 10 and within the liquid within the vessel 10.

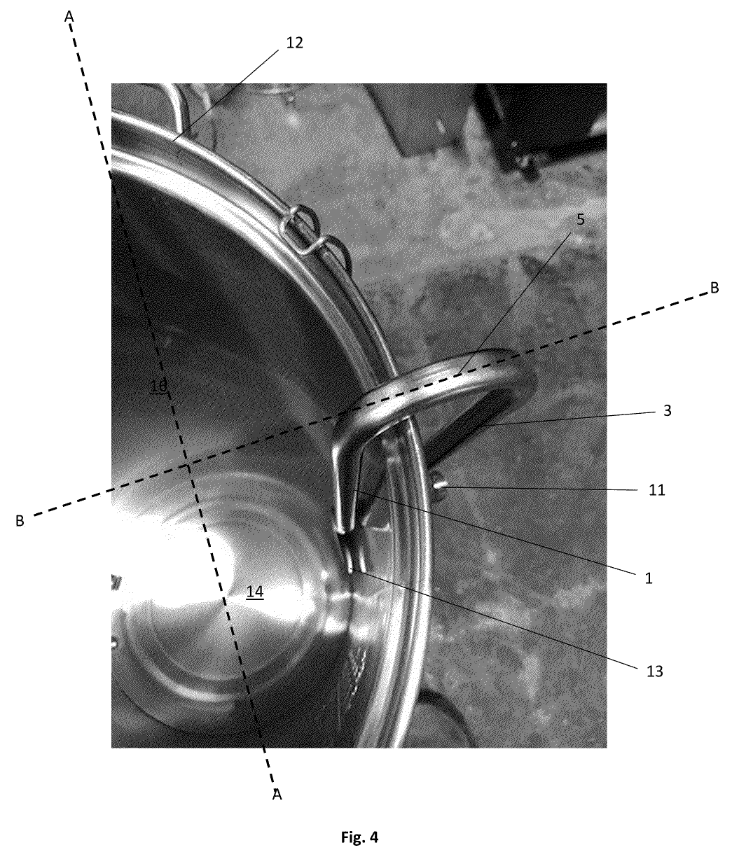

In some embodiments, a cam 7 can be positioned proximate to the gap 20. The gap 20 between the first arm portion 1 and second arm portion 3 can be between about 1 mm to about 3 cm, or between about 5 mm to about 2 cm, or about 1 cm. In some exemplary embodiments, there can be no gap and the first arm portion 1 and second arm portion 3 can contact each other. The composition of the apparatus 100 can allow for some flex or bending between the first arm portion 1 and second arm portion 3 to allow a user to create a gap 20 when applying the apparatus 100 to a vessel 10. In some exemplary embodiments, a portion of each of the first arm portion 1 and second arm portion 3 can contact interior 16 and/or exterior 18 vessel walls respectively as shown in FIG. 4. FIG. 4 further illustrates the cross-section portions (A-A and B-B) illustrated in FIGS. 3A-B. A portion of the first arm portion 1 and second arm portion 3 can apply a compressive force against the vessel sidewall to maintain the apparatus 100 in position on the vessel 10. The first arm portion 1 can apply pressure against the interior wall 16 of the vessel 10 and the second arm portion 3 can apply pressure against the exterior wall 18 of the vessel 10. Additionally, in some exemplary embodiments, one or more cams 7 can further help in aiding additional pressure against the vessel wall.

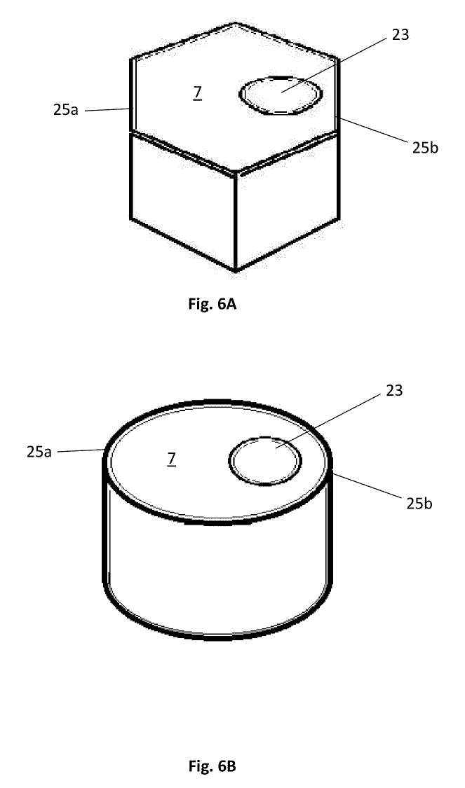

As shown in FIGS. 1, 2, and 6A-B, a stopper apparatus or cam 7 can be located proximate to the second end of the second arm 3 of the vortex apparatus 100. The cam 7 can take any suitable shape, including but not limited to cylindrical (FIG. 6B) or polygonal in nature. As shown in FIG. 6A, in some exemplary embodiments the cam 7 can be polygonal in shape and comprised of any suitable material, including but not limited to rubber. The cam 7 can be configured to provide a restrictive or friction force against the exterior surface 18 of the vessel 10. In some exemplary embodiments utilizing the cam 7, the cam 7 can have an aperture 23 that approximates the exterior circumference of the tube of the second portion 3 of the vortex apparatus 100. In other embodiments, the cam 7 can be positioned on the first arm portion 1 of the vortex apparatus 100, or alternatively on each of the first arm portion 1 and second arm portion 3 of the vortex apparatus 100.

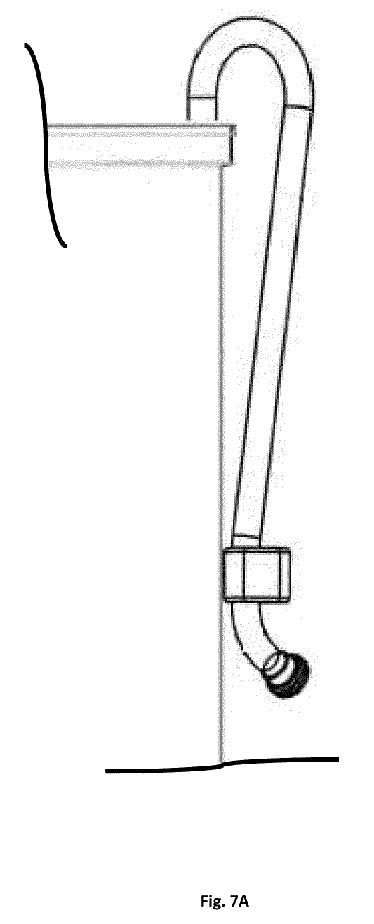

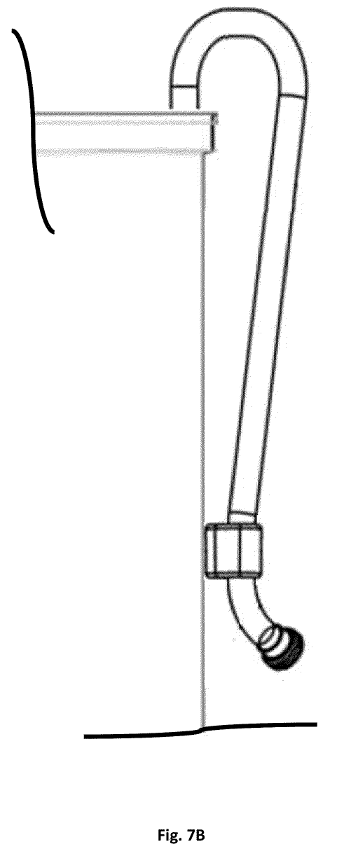

When the vortex apparatus 100 is placed over the lip 12 of the vessel 10 the cam 7 can be rotated to firmly tighten the apparatus 100 into position on the vessel 10. In some exemplary embodiments the aperture 23 of the cam 7 can be located off center to allow for a user to rotate the cam 7 around the tube to change the distance between the second arm portion 3 and the sidewall of the vessel 10. As shown in FIGS. 6A-6B, the aperture 23 can be positioned off center and a first edge of the aperture can have a first distance between a first edge 25a of the cam 7 and the center of the aperture. Ana a second edge of the cam 25b can a have a second distance between the second edge 25b and the center of the aperture 23. In some exemplary embodiments the first distance and second distance can be the same or different. If the first distance and second distance are different, this can result in the center of the aperture having a different distance from one or more of the various edges of the cam 7 and allows a user to easily adjust the position of the cam 7 by rotating around the second arm portion 3 of the apparatus 100 to increase or decrease the pressure the rubber cam 7 exerts against the vessel wall. As shown in FIG. 7A the cam 7 can be positioned in a first position wherein the second arm 3 can have a first distance from the exterior vessel wall 18. FIG. 7B illustrates the cam 7 positioned in a second position wherein the second arm 3 has a second distance from the exterior of the vessel wall. In these exemplary embodiments, the second position results in the second distance being greater than the first and can additionally result in a stronger compressive force against the vessel wall. The adjustability of the cam 7 can also be used to account for vessel wall thickness. Similarly, to change the height of the outlet of the whirlpool, a user can move the device up and down as desired. In some exemplary embodiments as shown in FIG. 5, a cam 7 can be located toward the center of the device, the second arm portion 3 can be about half the length of the first arm portion 1, wherein torque reaction from the thrust of the or liquid travelling out of the outlet 13 can be reduced by half. In addition, the cam 7 design allows simple intuitive positioning and tightening features all the while allowing for various thicknesses of kettles. Similarly, in some exemplary embodiments, an outlet portion can include a bend portion that has a bend of between about 60 to 120 degrees, or between about 75 to 110 degrees, or about a 90-degree bend from the first axis and configured to direct any fluid flowing out the outlet. The 90-degree bend can be formed into the first arm portion 1 or alternatively a fitting can be coupled to the end of the outlet 13 to provide the bend portion at the end of the outlet portion.

During the brewing process a recirculation pump and hose can be used and coupled to the vortex apparatus 100 to circulate the wort in the brewing vessel. The wort can be pumped from an outlet valve 22 of the kettle and into the threaded inlet end 9 of the vortex apparatus. The wort/liquid can flow through the inside of the tube and discharges tangentially on the sidewall of the kettle. The velocity of the flowing wort can cause the wort in the kettle to rotate and form a whirlpool. In addition to using the invention for settling out sediment, it can also be used for improving the efficiency of immersion chillers and HERMS coils as the flowing liquid over the cooling/heating coil increases turbulence and thereby increasing effectiveness.

In some exemplary embodiments, a liquid within the vessel can be drawn from a valve located proximate to the bottom of the vessel through a tube or by other means, a pump can then be used to move the liquid from the valve through a hose or tube to the inlet of the apparatus of the present disclosure. The liquid can flow through the apparatus and out the outlet end of the vortex apparatus of the present disclosure.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A removably couplable vortex apparatus for a brewing vessel comprising:
a first arm portion having a first end and a second end, wherein the second end include an outlet portion, wherein the first arm portion is positioned within an interior of the vessel;
a second arm portion having a first end and a second end, wherein the second end includes an inlet portion, wherein the second arm portion is positioned on an exterior of the vessel; and
a curved portion, having a first end and a second end, wherein the first arm portion extends a first predetermined distance from the first end of the curved portion and the second arm portion extends a second predetermined distance from the second end of the curved portion.

2. The apparatus of claim 1, further comprising a cam including a cam body and one or more sides, wherein the cam is configured to provide a friction force against a wall of the vessel.

3. The apparatus of claim 2, wherein the inlet portion includes a coupling means.

4. The apparatus of claim 3, wherein the coupling means is a threaded fitting.

5. The apparatus of claim 2, wherein the cam is polygonal in shape and further includes an aperture.

6. The apparatus of claim 5, wherein the aperture is positioned off center of the cam body.

7. The apparatus of claim 6, wherein a first predetermined distance between the center of the aperture to a first side of the cam is greater than a second predetermined distance between the center of the aperture and a second side of the cam.

8. The apparatus of claim 6, wherein the first predetermined distance is more than the second predetermined distance.

9. The apparatus of claim 1, wherein the first arm portion extends along a first axis.

10. The apparatus of claim 1, wherein the outlet portion includes a 90 degree bend from the first axis and is configured to direct any fluid flowing out the outlet.

11. The apparatus of claim 1, wherein the outlet portion has a 90 degree bend formed from the first axis and is configured to direct any fluid flowing out the outlet.

12. A method for creating a vortex sufficient to settle hops and trub in the center of a brewing vessel comprising:
removably coupling a vortex apparatus comprising:
a removably couplable vortex apparatus for a brewing vessel comprising:
a first arm portion having a first end and a second end, wherein the second end include an outlet portion, wherein the first arm portion is positioned within an interior of the vessel;
a second arm portion having a first end and a second end, wherein the second end includes an inlet portion, wherein the second arm portion is positioned on an exterior of the vessel; and
a curved portion, having a first end and a second end, wherein the first arm portion extends a first predetermined distance from the first end of the curved portion and the second arm portion extends a second predetermined distance from the second end of the curved portion; and
pumping a liquid from withing the vessel from a vessel outlet to the inlet portion to redirect the liquid through the vortex apparatus and through the outlet back into the vessel.

13. A removably couplable vortex apparatus for a brewing vessel comprising:
a first arm portion having a first end and a second end, wherein the second end includes an outlet portion, wherein the first arm portion is positioned within an interior of the vessel;
a second arm portion having a first end and a second end, wherein the second end includes an inlet portion, wherein the second arm portion is positioned on an exterior of the vessel;
a curved portion, having a first end and a second end, wherein the first arm portion extends a first predetermined distance from the first end of the curved portion and the second arm portion extends a second predetermined distance from the second end of the curved portion; and
a cam having an aperture to allow for a user to rotate the cam around the vortex apparatus and to provide a compressive force between the vessel wall and the vortex apparatus.

14. The removably couplable vortex apparatus of claim 13, wherein the first arm portion extends from the curved portion and extends parallel down an interior wall of the vessel and the second arm portion extends from the curved portion at an angle towards an exterior wall of the vessel.

15. The removably couplable vortex apparatus of claim 14, wherein the aperture is positioned off center and a first edge of the aperture has a first distance between the center of the aperture and the first edge and a second edge of the cam is a second distance from the center of the aperture.

16. The removably couplable vortex apparatus of claim 15, wherein the cam is rotatable the vortex apparatus to change the distance between the second arm portion and the sidewall of the vessel.

17. The apparatus of claim 16, wherein the inlet portion includes a coupling means.

18. The apparatus of claim 17, wherein the coupling means is a threaded fitting.

19. The apparatus of claim 18, wherein the cam is polygonal in shape and further includes an aperture.
